(19) United States
(12) Patent Application Publication
(10) Pub. No.: US 2005/0075930 A1
(43) Pub. Date: Apr. 7, 2005

(54) Methods and system for allocation of rewards and mapping activity within organizations

(76) Inventors: Azhar Hussain, London (GB); Hafizur Rahman, London (GB)

Correspondence Address: KAPLAN & GILMAN , L.L.P., 900 ROUTE 9 NORTH, WOODBRIDGE, NJ, 07095, US

(21) Appl. No.: 10/922,822

(22) Filed: Aug. 19, 2004

Related U.S. Application Data
(60) Provisional application No. 60/496,414, filed on Aug. 20, 2003.

(51) Int. Cl. G06F 17/60

(52) U.S. Cl. 705/14; 705/11

(57) ABSTRACT

Methods and systems for allocating rewards and mapping activity within organizations. Rewards are allocated throughout an organization using a consensus driven model and peer review. In one embodiment employees enter into a system “scores” for fellow employees based on at least one set of criteria. Once the scores are entered the system processes them according to an algorithm in accordance with the present invention and generates an output. In one embodiment the output is generated in the form of a report for management. Amps can be generated to assist in analysis of value within an organization.

### CROSS REFERENCE TO RELATED APPLICATIONS

This application claims the benefit of U.S. Provisional Patent Application No. 60/496,414, entitled METHODOLOGY FOR ALLOCATION OF REWARDS AND MAPPING FLOWS WITHIN CORPORATIONS, filed Aug. 20, 2003, the entire disclosure of which is hereby incorporated by reference.

### BACKGROUND OF THE INVENTION

The present invention relates to methods and systems for allocating rewards and mapping activity within organizations.

In the current climate of the negative press that surrounds fat cat remuneration the constant question of combining motivation and reward with risk and effort remains ever-present. Aligning shareholder value with employee rewards has seen many different permutations of schemes and strategies. However these have been dogged with technical problems ranging from tax, accounting and market force issues to problems stemming from human influence such as politics, nepotism and inconsistent application. This is further complicated by the increasing globalization of corporations and workforces. In addition, most of these schemes depend at least in part on events upon which an employee has no direct influence, such as the organization as a collective achieving profitability goals, the broader economic backdrop, or the stock price on the public markets. Current bonus systems are typically costly in administration time and cost and produce an adverse effect on morale when poorly implemented. In addition, reward distribution is typically perceived as a highly biased process, and distribution schemes are subject to abuse by administrators. As a result, prior art reward distribution schemes are vulnerable to legal challenges on the basis of discrimination. In view of the foregoing, prior art reward distribution schemes do not meet the objectives of providing transparent, trusted and equitable rewards to organization members

Accordingly, it would be advantageous to provide a reward method and system largely immune from negative human influence that ties the performance of the individual to a fair and proportionate reward as judged by peers, wherein each employee has a direct stake in achieving his or her goals and these are rewards are tied directly to progress achieved.

### SUMMARY OF THE INVENTION

The present invention is directed to methods and systems for allocating rewards and mapping activity within organizations. In accordance with one or more embodiments of the present invention rewards are allocated throughout a corporation using a consensus driven model and peer review. In one embodiment employees enter into a system “scores” for fellow employees based on at least one set of parameters. Once the scores are entered the system processes them according to an algorithm in accordance with the present invention and generates an output. In one embodiment these scores are not merely notional but represent real world “currency”, such as money, vouchers or the like. The output is capable of being used to identify value pockets and holes in the organization. In one embodiment the output is generated in the form of a report for management. In accordance with the present invention, the larger the size of the sample, the less likely a single individual can affect the output.

In some embodiments the invention also identifies activity and value flows within the different parts of the organization as judged by the organization as whole, preferably represented in the form of maps where relative size and position are used to signify different metrics.

The methods and system of the present invention deliver a fair and accurate representation of the value being delivered by each unit of an organization, be it employee, department or division. The result is a truly meritocratic process through which rewards can be allocated throughout the organization. In accordance with some embodiments of the invention, the methods have the added benefits of being transparent while respecting individual confidentiality and requiring minimum management time to administer. In addition, because it is largely driven by technical processes providing a traceable link between evaluation and rewards, the reward allocations generated by implementation of the present invention are robustly defensible against union or legal challenges. Unlike the prior art, the methods and systems disclosed herein encourage teamwork & knowledge sharing. In order to maximize personal reward allocation according to the present teachings, an individual must consistently excel at the attribute being measured. This means, for example, making a tangible difference to creating a collaborative working relationship as judged by all those with whom the individual collaborates. This extends to knowledge sharing, proactive initiative, creative thinking, going the extra mile, and the like. The attributes that need to be measured are those the organization chooses to prioritize. In any organization, only what is measured is managed and implemented.

In one aspect of the present invention a method of allocating rewards in an enterprise is provided comprising the steps of providing to individuals in said enterprise at least one criteria and at least one score or scale that may be applied to said criteria, requesting said individuals to apply said score or scale to said criteria as it applies to other individuals in said enterprise, recording said application, and processing the results of said application. In a preferred embodiment the results are further processed to generate a reward map such as but not limited to an activity map, competency map and/or entity spread value chart. In a most preferred embodiment the present invention contains algorithms that identify potential patterns consistent with trading of points or breaches of confidentiality. However, the driving algorithm of the present invention ensures that it is the collective opinion of all involved that allocates rewards to individuals within the group.

In a most preferred embodiment the present invention employ anonymous, confidential submissions not shared among employees.

According to one embodiment the present invention is implemented through the Internet. In particular, without limitation, systems and methods of the present invention comprise in one embodiment a host computer connected to a network, a client computer connected to the network, a reward allocation program in accordance with the present invention located on said host computer accessible from said client computer via a website. Alternatively, a reward allocation program in accordance with the present invention may be installed on said client computer by way of a disk or downloading the program from said host computer via a web site.

In one embodiment the present invention provides a system adapted to allocate rewards in an enterprise comprising a means for generating criteria upon which at least one individual in said enterprise may be evaluated, a score or scale adapted to be applicable to said criteria, a means for individuals in said enterprise to record at least one evaluation by applying the score or scale of at least one individual in said enterprise, a means for compiling said recorded data and processing said data. In a preferred embodiment the system further comprises a means for generating a reward allocation map based on said data.

In accordance with one or more further aspects of the present invention, the methods and systems described thus far and/or described later in this document, may be achieved utilizing suitable hardware. Such hardware may be implemented utilizing any of the known technologies, such as standard digital circuitry, analog circuitry, any of the known processors that are operable to execute software and/or firmware programs, one or more programmable digital devices or systems, such as programmable read only memories (PROMs), programmable array logic devices (PALs), any combination of the above, etc. Further, the methods of the present invention may be embodied in a software program that may be stored on any of the known or hereinafter developed media.

Other aspects, features and advantages of the present invention will become apparent to those skilled in the art when the description herein is taken in conjunction with the accompanying drawing.

### BRIEF DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a flow chart in accordance with one or more aspects of the present invention;

FIG. 2 is a flow chart in accordance with one or more aspects of the present invention;

FIG. 3 is a chart containing data generated in accordance with one or more aspects of the present invention;

FIG. 4 is a map containing data generated in accordance with one or more aspects of the present invention;

FIG. 5 is a graphical representation of data generated in accordance with one or more aspects of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” in various places in the specification are not necessarily all referring to the same embodiment.

In accordance with one embodiment of the present invention a method of allocating rewards in an organization comprises the steps of providing to individuals in said organization at least one criteria and at least one awardable score or scale that may be applied to said criteria, requesting said individuals to apply said score or scale to said criteria as it applies to other individuals in said enterprise, recording said application; and processing the results of said application. In a preferred embodiment the results are further processed to generate a reward map such as but not limited to an activity map, competency map and/or entity spread value chart.

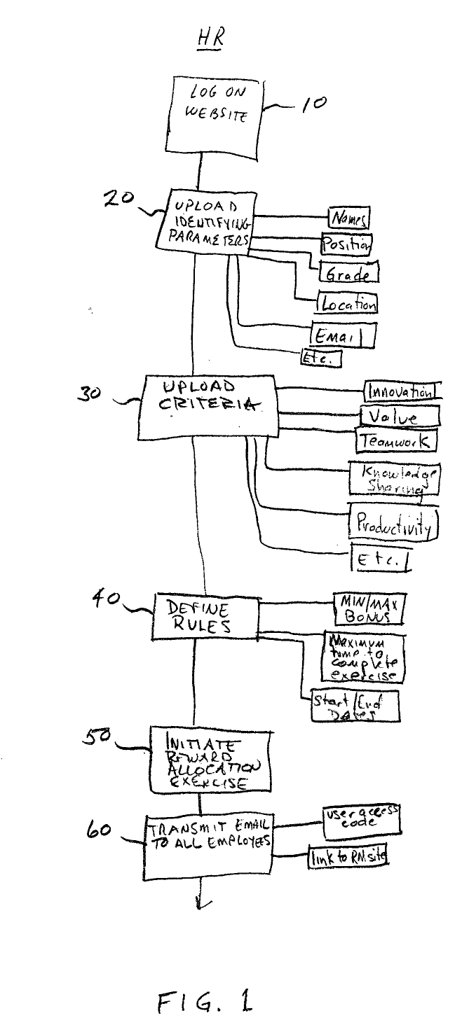

Now referring to FIG. 1 in one embodiment a reward allocation exercise in accordance with the present invention is implemented according to a series of steps in which a representative of an organization such as but not limited to a human resources representative in block 10 logs on, via a wide area network such as the Internet, a website upon which reward allocation software according to the present invention resides. It is to be understood that reward allocation software may be resident on client hardware such as an organization's server rather than being accessible only through a website. It is to be further understood that the present invention can be deployed in a stand-alone mode on a personal computer, not requiring a network environment.

In block 20 the representative is prompted to upload identifying parameters relating to personnel that are to be included in a reward allocation exercise. Such parameters are preferably entered into a template resident on said website. Parameters may include but are not limited to names, position, grade, location, email and other personnel-defining parameters. In block 30 the representative uploads criteria defining the characteristics personnel will evaluate in allocating points to other personnel in the organization. These criteria may include but are not limited to innovation, value, teamwork, knowledge sharing, productivity and the like. In block 40, the representative uploads the rules to which personnel must adhere when participating in the reward allocation exercise. Such rules may include the minimum an/or maximum number of points personnel may allocate, a time limit within which the exercise must be completed, start and end dates for evaluation period and the like. In block 50 the representative then initiates the reward allocation exercise, such as by, in block 60, transmitting a notification such as but not limited to an email to all personnel to be included in the exercise. Notification may be effected via mobile text messaging, postal mail, instant messaging and the like; essentially, any one-to-one communication channel that, in the ordinary course of events is calculated to be uniquely accessible by the intended recipient may be employed. Such notification preferably includes a user access code unique to the recipient and other information such as a link to the reward allocation website. Alternatively, for example, the notification may include a reference to a web site where the participant may log on with the details supplied in the notification, or in a previous or separate communication.

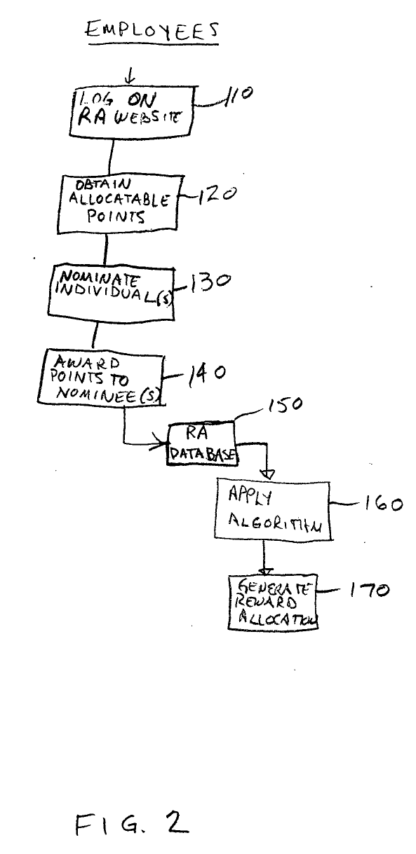

Now referring to FIG. 2, in block 110 participating personnel access the reward allocation website (or program if it is resident on the organization server) using their unique access code. Upon entry to the website, in block 120 the participant is advised of the number of allocatable points that participant has been given. The allocatable points are points a given participant may allocate to other participants. The participant is then prompted in block 130 to nominate an individual or individuals based on the criteria described in connection with block 30 hereinabove. In block 140 the participant awards some or all of its allocatable points to the nominee(s) the participant has selected. A participant is not required to allocate all allocatable points but preferably participants are encouraged to do so, such as by appropriate phrasing of questions in the data capture process.

Once points are allocated to nominees, the information is stored in the reward allocation database in block 150 and in block 160 a reward allocation program algorithm is applied to generate the appropriate reward allocation in block 170.

Preferably participants are permitted to award points to anybody in the entire organization. In some embodiments, however, it may be desirable to permit individuals external to the organization to participate in the reward allocation exercise process to a limited degree, that is, permitted to award points but not to receive nominations or points. Only awarded points are eligible for any bonus calculation. Depending on the discretion of the organization, unallocated points may be canceled, allocated to participating personnel in accordance with the percentages of points allocated by others in the organization, spread throughout the organization in accordance with the relative salaries of each participant or otherwise distributed. While each participant can theoretically accumulate as many points as possible from the entire organization, the maximum for the purposes of the reward calculation is most preferably limited to the total number of points that were originally available for allocation so as to keep the overall bonus figure within budget. However, in a preferred embodiment the actual number of points received is recorded and is used as a basis for additional recognition.

In accordance with another embodiment, participants can be restricted from allocating a specified proportion of his or her points to another individual. Participants may also be restricted to awarding no more then a specified proportion of points within their immediate group. Other examples of restrictions that can be implemented are limits on the number of individuals that can be nominated (and hence receive points), the number of criteria that may be measured for any single individual, the number of points any one individual can receive, and the like.

In a most preferred embodiment a system according to the present invention contains algorithms that identify potential patterns consistent with trading of points or breaches of confidentiality. However, the driving algorithm of the present invention ensures that it is the collective opinion of all involved that allocates rewards to individuals within the group.

In a most preferred embodiment method in accordance with the present invention employ anonymous, confidential submissions not shared among employees. Anonymity is preferred so methods and systems in accordance with the present invention work optimally, as individual identification as the source of points would skew the allocation process. Individual anonymity is also preferably protected to ensure confidence in the system and that the basis of allocation is as fair and as neutral as possible.

In one embodiment a company administrator wanting to administer a reward allocation according to the present invention logs onto a website and uploads selected parameters required to identify users within the administrator's organization preferably via a secure encrypted channel. Such parameters might include names, position, grade, location, email, salary and the like. In a preferred embodiment the administrator uploads a questionnaire adapted to capture both numeric and narrative information. Once the upload is complete, the company administrator creates a custom text that is then emailed to all the users in the group. Included in the text is a statement of allocatable points a user can apply to others n the group according to criteria set by the administrator. Preferably, included in the email is a unique password and username along with a completion date that the user must complete the exercise by.

Once the user logs on, he or she is presented with a private session that allows them to complete the questionnaire. Through this process the user allocates the points that each individual has to others in the organization. This process can also be extended to products or services for which people or teams are responsible. In one embodiment the allocatable points vary in value or quantity according to the person to whom they are allocated. This makes the points valuable across the organization, irrespective of rank, and builds an incentive to gain as many points as possible.

In alternate embodiments certain operations may be performed manually. For example, the questionnaire can be prepared off-line by an administrator (or obtained by the administrator from a third party vendor of such questionnaires) and mailed to individuals for their manual completion. The questionnaire can then be mailed back to the administrator for tabulation of results.

The relative value of a point is set by the size of the reward set by the company for distribution. To the individual the points are worth a proportion of the total bonus they can achieve. Thus the more points they accumulate, the higher the level of bonus. Points preferably translate into cash, however, it is up to the organization how it wishes to reward its employees. Accordingly, points may be translated into vacation days, stock options, vouchers or coupons, prizes or the like. Since the points are awarded by coworkers across the organization, a realistic picture of the value an individual is delivering in their professional capacity is reflected. While all points don't have to be allocated, any unallocated points are cancelled or distributed at the discretion of the organization. The maximum payout will never exceed the total amount allocated for reward.

In certain embodiments it may be desirable for an organization to vary the number of allocatable points among employees. For example, an organization may choose to provide a greater number of allocatable points to employees with more seniority, or to those employees who scored highest in a previous administration of a reward allocation exercise, or the like. Likewise, an organization may desire to introduce a “weight” factor to points so that under certain circumstances points will automatically be more or less heavily weighted. For example, an organization may wish to weight more heavily points received by individuals who have a good attendance record or have reached a certain level of service.

### EXAMPLE 1

Calculating Bonus Award X

The formula used to arrive at the bonus figure X is [(B×S/ΣS)×1/A]×R where

B=Total Bonus payout to be spread across target population;

S=Individual Salary level of population member

A=Points Allocated to population members for onward allocation to other members

R=Points Rewarded by population members to other members of the same group.

According to this formula R≦A, that is, the points rewarded to an individual must not be greater than the points available for allocation by members of the target population. If applied correctly, B≧ΣX when points are fully distributed. Should the individual distribution be less then A, then B will not be fully used.

The value of A is derived by the granularity of rating required by the organization conducting the exercise. A can represent a point value or a maximum of a scale, e.g., A=10 on a scale of 1-10.

The following is an example of how the foregoing formula is applied.

ABC Inc. has a workforce of 15 people. Their total wage bill for a period comes to $870,000. Over the same period, the company has made a profit and decides to pay a bonus to the employees. The bonus to be distributed is $225,000.

ABC Inc. decides to use the reward allocation method in accordance with the present invention to distribute the bonus to the employees. The company accesses the reward allocation website via the Internet uploads the information necessary to create the exercise in which employees of the company will participate. In this example the employees are asked to rate others in the organization on a scale of 1 to 10. After the employees have completed the exercise through the website, the final score for each employee (in this case, determined by dividing the total number of points an employee receives by the number of employees who applied points to that employee) out of the maximum 10 is found.

The formula above is applied to arrive at the bonus figure, X, where B=225,000; S=Individual Salary level of population member; A=10; and R=Points Rewarded by population members to other members of the group.

Table 1 reflects the results of this exercise:

TABLE 1

| Employee | Salary [S] | Points Rewarded [R] | Bonus Awarded [X] |
|---|---|---|---|
| E1 | 350,000 | 1 | 9,052 |
| E2 | 100,000 | 10 | 25,862 |
| E3 | 35,000 | 6 | 5,431 |
| E4 | 22,000 | 4 | 2,276 |
| E5 | 7,000 | 7 | 1,267 |
| E6 | 81,000 | 8 | 16,759 |
| E7 | 12,000 | 9 | 2,793 |
| E8 | 42,000 | 2 | 2,172 |
| E9 | 44,000 | 5 | 5,690 |
| E10 | 16,000 | 3 | 1,241 |
| E11 | 23,000 | 4 | 2,379 |
| E12 | 30,000 | 8 | 6,207 |
| E13 | 55,000 | 5 | 7,112 |
| E14 | 42,000 | 10 | 10,862 |
| E15 | 11,000 | 10 | 2,845 |

Alternatively, an organization may wish to conduct an exercise by way of a complex questionnaire in which a plurality of criteria are employed, each criteria having a specific number of points that an employee participant can apply to others in the organization. For example, a company may wish to employ a questionnaire in which employees are asked to rate others in the organization on the basis of the criteria “Effective Listener”, in which a total of 10 points is given to each employee that may be allocated to others. Conditions may be imposed on the participant, such as “60% of nominations (persons receiving points from the participants) must be made within your own team”, and “No individual can receive more than 15% of the points allowed for this criteria”. Thus, according to this example a participant can award no more than 1.5 points to any one individual. In this way, the organization (through the administrator) can ensure the value A is not exceeded for any one individual.

Any other criteria or competencies can also be employed, such as but not limited to Innovation, Problem Solving, Market Oriented, High Standards, Determined, Effective Evaluator, Strong Thinker, Creative, Clear Communicator, Proactive, Detail Oriented, Customer Focused, Flexible, Conflict Management, Technical Knowledge, Company Knowledge, Effective Prioritization, Positive Attitude, Corporate Approach, Results-Oriented, Competitive, Approachable, Relationship Builder and the like. It is up to the organization to determine what conditions or restrictions are placed on each criterion. For example, in the event multiple criteria are employed, an organization may decide to limit the number of categories a participant may be nominated for, and receive points in, by another participant.

In a preferred embodiment, the system according to the present invention contains a plurality of prepared questionnaires from which an administrator can choose and use unchanged, or modifies according to the needs of the organization. The administrator may alternatively upload his or her own custom questionnaire.

Employing the data gathered from execution of an exercise according to the present invention allows a wealth of additional analysis. In one embodiment maps are created showing where the organization perceives the value to be.

The allocation of points by individuals creates relationships that can be mapped. These maps can be used to summarize the activity levels within a groups as well as identifying the key relationships that drive the business forward on a day-to-day basis. The following maps are exemplary and not intended to be exhaustive. Moreover, parameters other than those appearing in the following maps may be employed.

Value Grid

The departments ranked by most value to the company. This is measured by the highest number of value points achieved as an average for the department.

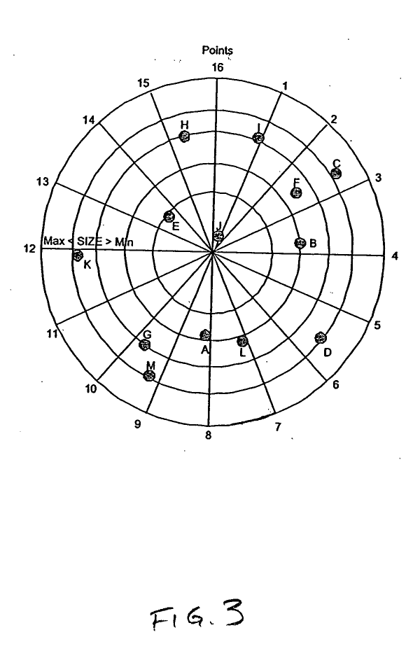

Now referring to FIG. 3, a value grid illustrates the levels of meaningful interaction within a corporation. A graphical engine examines the entities (departments, divisions, groups) to which users are allocating the points. Each is then allocated onto a circular target. Each concentric ring is indicative of size of the department from the smallest to the largest. The target is split into segments with each segment representing a level of points scored.

For example, DEF Inc. has conducted a bonus allocation exercise according to the present invention. The company is made up of 10,000 employees over 13 departments (A-M). They have employed a 16 point scale for allocation to various individuals. Each department is plotted on the chart to create a map where the points are shown on the circumference. Concentric rings indicating department size, running from small to large from the center to the periphery. The individual score is averaged over the entire department. In this example, Dept H was the best and Dept I was the worst in terms of perceived value from the rest of the organization.

At a glance this allows all the entities to be compared by the value the organization as a whole sees them contributing. Each representative entity can be further drilled down and broken into its constituent parts.

Activity Maps

An activity map illustrates the levels of meaningful interaction within an organization, illustrating the flow of value recognition throughout the organization. A graphical engine examines the entities (departments, divisions, groups) allocating the points and those receiving them.

Once the points have been allocated according to the present invention various types of analyses can be performed in order to unveil cross-functional behaviors. For example, mapping the flow of points from one department, for all the departments in an organization would show which teams work together, how strongly a particular department is valued by the others, what are the real networks that drive the organization, whether value recognition is mutual or does it flow through the organization in any particular pattern and how this compares with the process workflows within the organization.

To aid clarity a sensitivity threshold can also be applied to an activity map. This eliminates relationships that are formed using accumulated points that fall below the set threshold. In this way only those relationships that are a result of significant recognitions are highlighted.

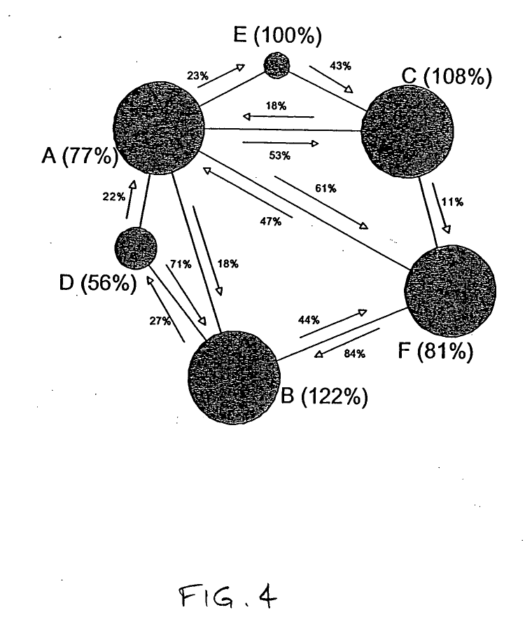

Now referring to FIG. 4 an activity map is depicted. FIG. 4 illustrates an activity map in which FGH Inc. has employed the method of the present invention to evaluate rewards for its employees. The organization is made up of 6 divisions A-F. The organization is also interested in identifying how the employees interact across the organization and the value they attach to these interactions. The arrows indicate the direction of flow of points and the proportion of accumulated points available to each division allocated from one division to another. Against each division is the number of points attained at the end of the exercise as a proportion of the total. The size of each sphere indicates the relative size of the divisions.

According to FIG. 4, Division E had the same number of points as the end of the exercise as it did in the beginning. During the exercise, individuals within the division allocated 43% of their points to Division C while receiving 23% of Divisions A's points. This indicates broadly that the division E is seen as delivering value by the organization as a whole. This contrasts against Division D that is not considered as delivering the same kind of value.

Competency Maps

A competency map refines an activity map by focusing on single department and viewing the rest of the organization from that viewpoint. Filters are applied to the competency map that highlight that department's view of other parts of the organization in terms of attributes the firm wishes to measure.

The data is derived during the data capture phase by asking employees to consider these attributes during the points allocation phase. The attributes are likely to be those that that firm wishes most to encourage, such as innovation, customer focus, knowledge sharing, balanced risk taking, productivity, delivery and the like. As a result, the overall Competency Map can be distilled into the underlying component behaviors, enabling one to see where the strengths lie.

Entity Spread Value Charts

Entity spread value charts allow analysis of the spread of points within a group, crucial in determining the weighting of perceived value across the group as a whole. For example, it is possible that a proportion of the group is perceived to be that which carries the entire group. This chart allows the spread to be analyzed against the average for the same group as ranked by the organization.

The chart itself can be set to analyze higher order entities, such as divisions or departments. The user can then drill down through to team and department. For comparison all the entities on the chart are preferably at the same level within the hierarchy although for contrast, the parent entity's spread value chart can also be shown.

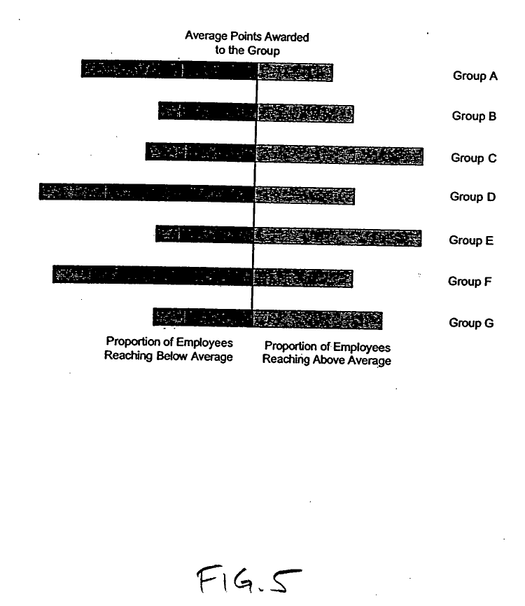

Now referring to FIG. 5, an entity spread value chart is depicted in accordance with the following example. ABS Inc. has completed a reward allocation exercise in accordance with the present invention. It now wants to analyze the results and identify the spread of perceived value within the 7 different groups. It uses the Entity Spread Value Chart and arrives at the analysis shown in FIG. 5

The black bars indicate the proportion of employees who did not attain any points against that particular metric. ABS In. identified that Group F had the highest proportion of employees who were perceived as delivering below average value compared to the rest of their group. Conversely Group C had the highest proportion of employees achieving above average value compared to the group as a whole.

While the preferred embodiments have been described and illustrated it will be understood that changes in details and obvious undisclosed variations might be made without departing from the spirit and principle of the invention and therefore the scope of the invention is not to be construed as limited to the preferred embodiment.

1. A method of allocating rewards in an organization comprising the steps of:
providing to at least one individual in said organization at least one criteria and at least one score that may be applied to said criteria;
requesting said individual to apply said score to said criteria as it applies to at least one other individual in said organization;
recording said application; and
processing said results.

2. The method according to claim 1 further comprising generating a reward map from said results.

3. The method according to claim 1 conducted via a computer terminal linked to a wide area network.

4. The method according to claim 1 further comprising requesting said individual to nominate at least one individual that will receive a score.

5. The method according to claim 1 comprising placing conditions on the score an individual is permitted to apply to said criteria.

6. The method according to claim 1 comprising placing conditions on the number of criteria an individual is permitted to apply to a nominated individual.

7. The method according to claim 2 said reward map comprising a value grid.

8. The method according to claim 2 said reward map comprising an activity map.

9. The method according to claim 2 said reward map comprising a competency map.

10. The method according to claim 2 said reward map comprising an entity spread value chart.

11. The method according to claim 1 said score attributed to said criteria facilitated by a questionnaire.

12. A system adapted to allocate rewards in an organization comprising:
a means for generating criteria upon which at least one individual in said organization may be evaluated; a score adapted to be applicable to said criteria; a means for individuals in said organization to apply at least one score to at least one criteria for at least one individual in said organization, and a means for compiling said recorded data.

13. The system according to claim 12 comprising a means for generating a reward map based on said data.

14. The system according to claim 12 comprising a computer terminal linked to a wide area network.

15. The system according to claim 12 said means for individuals in said organization to apply at least one score to at least one criteria for at least one individual in said organization comprising a questionnaire.

16. The system according to claim 12 said reward map comprising a value grid.

17. The system according to claim 12 said reward map comprising an activity map.

18. The system according to claim 13 said means for generating a reward map comprising a computer program.

19. The system according to claim 12 said reward map comprising an entity spread value chart.

20. A method of allocating a reward in an organization comprising:
providing to at least one individual at least one criteria and at least one score that may be applied to said criteria;
application by said individual of said score to at least one criteria as it applies to at least one individual in said organization; and
processing results of said application.
